(19) United States
(12) Patent Application Publication
(10) Pub. No.: US 2003/0211264 A1
(43) Pub. Date: Nov. 13, 2003

(54) Expanded polytetrafluoroethylene (ePTFE)-reinforced perfluoroelastomers (FFKM)

(76) Inventors: Ted Ray Farnsworth, Flagstaff, AZ (US); Ronald Gene Egres JR., Newark, DE (US)

Correspondence Address: W. L. Gore & Associates, Inc., 551 Paper Mill Road, P.O. Box 9206, Newark, DE, 19714-9206, US

(21) Appl. No.: 10/142,350

(22) Filed: May 9, 2002

(51) Int. Cl. B32B 1/08

(52) U.S. Cl. 428/36.9; 428/66.6

(57) ABSTRACT

A reinforced elastomer composite is disclosed comprising expanded polytetrafluoroethylene (ePTFE) and an FFKM polymer that preferably comprises monomer units of TFE and PAVE. At least a portion of the reinforced elastomer composite is substantially non-permeable. Further disclosed are methods of making the reinforced elastomer composites, and articles made therefrom.

### BACKGROUND

Perfluoroelastomers (FFKM elastomers) are known for their resistance to chemical attack and their excellent thermal stability (Brenzeale in U.S. Pat. No. 4,281,092). FFKM elastomers have been used as o-ring materials in difficult sealing applications for a number of years under the trademarks of Kalrez® by E. I. duPont de Nemours & Co. and Chemraz by Greene Tweed, Inc. These perfluoroelastomers are crosslinked to provide optimum mechanical performance.

Kalb, et. al., (Advances in Chemistry Series Issue 129, 1973) describe the chemistry of perfluoroelastomers based on copolymers of tetrafluoroethylene (TFE) and perfluoromethylvinylether (PMVE) that incorporate cure site monomers such as perfluoro(4-cyanobutyl vinyl ether), perfluoro(4-carbomethoxybutyl vinyl ether), perfluoro(2-phenoxypropyl vinyl ether), and perfluoro(3-phenoxypropyl vinyl ether). In particular, Pattison (U.S. Pat. No. 3,467,638) and Brizzolara (U.S. Pat. No. 3,682,872) describe fluorophenoxy cure site monomers used with TFE and PMVE to form crosslinked polymers. Gladding (U.S. Pat. No. 3,546,186), discloses and claims cure site monomers of the class having perfluoroalkyl cyano side chains. Apotheker (U.S. Pat. No. 4,035,565), claims the use of up to 3 mole % of a bromo perfluoroalkyl cure site monomer along with TFE and PMVE. Breazeale (U.S. Pat. No. 4,281,092) describes the use of cyano functional side chains including perfluoro-(8-cyano-5-methyl-3,6-dioxa-1-octene) to improve the thermal and oxidative stability of the crosslinked polymers. They also provide better resistance to acids and better compression set performance. In all cases, the cure site monomers enable the fluoropolymers to crosslink into three dimensional networks.

The production of FFKM articles can involve multiple steps of preparation, isolation, washing, drying, compounding, and molding as taught by Khan (U.S. Pat. No. 3,752,789). First, the gum polymer is produced by the emulsion polymerization of TFE, PMVE, and a cure site monomer. The gum is isolated from the emulsion by coagulating the polymer with high ionic strength chemicals such as a mixture of magnesium chloride hexahydrate, water, ethanol and sulfuric acid, washing the polymer to remove salts and surfactant, drying the polymer to remove water and residual volatiles, and masticating the polymer to form a slab. The isolated polymer is combined with reinforcing agents, such as titanium dioxide and silica, using a high shear, internal mixer. Fillers are often compounded into the gum prior to adding curatives due to the excessive heat generated upon mixing the filler into the polymer. Curatives are often added on a two roll mill to incorporate into the resulting compound without generating excessive heat that could lead to premature curing known as “scorch.” The compound can be extruded or molded into FFKM articles such as o-rings and gaskets with heat and pressure. The compounds are typically cured at temperatures of approximately 200° C. in closed cavity molds at elevated pressures. The cured parts are usually post-baked at temperatures between 200° C. and 300° C. for 48 hours in nitrogen to optimize their mechanical properties, especially, their resistance to compression set.

Effenberger, et. al. teach in U.S. Pat. No. 4,770,927, substrates of fluoroplastics, glass fabric, graphite, aluminum foil, polyolefins, etc., coated with fluoroelastomer latex materials. The coated substrates are particularly useful as chemical liners, expansion joints, protective coatings, etc. where flexibility and toughness are needed. Heat and pressure were used to laminate the FFKM onto the substrate to yield soft and flexible composites. FFKM elastomers have good mechanical properties, such as creep resistance; however, inorganic fillers are required to obtain significant durability. Inorganic fillers do not provide sufficient reinforcement for fatigue resistance and crack propagation for many flexing applications. Also, FFKM elastomers reinforced with inorganic fillers are prone to liberate particulates from flex cracking or abrasion. Thus, there has been a long-felt need for FFKM elastomers which are reinforced and which do not have the problems associated with particulate fillers. FFKM elastomers disclosed in the above background art can be improved by the incorporation of expanded polytetrafluoroethylene (PTFE) to avoid the contamination associated with the particulation of inorganic fillers, and to improve flexural endurance and strength.

PTFE is a unique compound that exhibits utility over a relatively wide range of temperatures and chemical and environmental conditions. PTFE is usable over a temperature range from about 260° C. to as low as near −273.0° C. PTFE is also highly resistant to attack from many harsh chemical reagents. U.S. Pat. No. 3,953,566 to Gore discloses production of a form of PTFE, expanded polytetrafluoroethylene (ePTFE), which is a porous material of interconnected voids formed by nodes and fibrils. The void space in ePTFE comprises at least 50% of the volume, and frequently more than 70%. ePTFE is often a higher strength material than PTFE, and it is also an excellent dielectric material. Incorporation of various fillers into ePTFE is also taught in U.S. Pat. No. 3,953,566 patent and in U.S. Pat. No. 4,985,296 to Mortimer, Jr.

Coating ePTFE with various coating materials is also known. For example, porous ePTFE substrates coated with PTFE were taught by Wu (U.S. Pat. No. 5,677,366). In this patent, microemulsions of nanometer size particles of PTFE were incorporated into ePTFE to provide enhanced oleophobicity without decreasing the air permeability. The microemulsions were applied by spraying on one side of the membrane and allowing the microemulsions to completely wet the membrane. Coated membranes were dried at 200° C. for 3 minutes to remove water and surfactant. The coated and uncoated substrates all had Gurley air flow numbers between 10 and 15 seconds, thus indicating a high level of porosity and air permeability.

The combination of ePTFE with other elastomers is also known. For example, in U.S. Pat. No. 6,239,223, Effenberger et al. teach blended solid compositions of a microparticulate fluoroplastic component and an elastomeric component. Effenberger et al. teach that the microparticulate fluoroplastic component is homogenously distributed throughout the composition and is originally incorporated in an unfibrillated state. The blended solid compositions are isolated from an aqueous blend of fluoroelastomer and microparticulate fluoroplastic materials that are unfibrillated yet fibrillatable. The formed compositions may be subjected to mechanical forces in subsequent processing to induce fiber formation of the particulates.

Tu (U.S. Pat. No. 4,816,339) describes the preparation of radially asymmetric vascular grafts having an elastomer content ranging from 5 to 120 weight percent ratio of elastomer relative to PTFE. Tu teaches the use of fluoroelastomers, silicone elastomers, and others. A typical process used for producing a multi-layer PTFE/elastomer implant includes blending the PTFE fine powder with the solvated elastomer, preforming a multi-layered billet, extruding out of a die, curing the elastomer, expanding the composite, and forming an optional elastomeric polymer coating layer via a dip or spray coating operation. Other tubular prostheses have been developed by Mano (U.S. Pat. No. 4,304,010) which comprise a porous tubing of PTFE having a microstructure composed of fibrils and nodes connected to one another by the fibrils, the fibrils being radially distributed, and a porous coating of an elastomer bound to the outside surface of said PTFE tubing. The prosthesis can be vacuum impregnated with elastomer solution to provide a coating thickness of between 20 and 500 microns. The prosthesis has improved suture tear resistance when compared to previous art.

Composites of elastomer and ePTFE having a plurality of layers are disclosed by Zumbrum et. al. (WO 99/41071) which teach composites having superior flexure endurance. Multilayered, liquid elastomer-impregnated ePTFE structures, in particular, liquid silicone polymer-impregnated ePFTE structures, may be adhered together by layers of elastomer, and are subsequently compression molded to form crosslinked composites for peristaltic pump tubes. Liquid perfluoropolyether polymers are also disclosed in the impregnation of ePTFE. In all cases, hydrophobic, liquid elastomers were impregnated into hydrophobic, expanded PTFE, thus resulting in spontaneous wetting and impregnation of the microporous PTFE.

PTFE has also been combined with FFKM elastomers by working with solid films of both polymers. They can be laminated together to form a composite; however, due to the high viscosity of the FFKM polymer, high pressure molding of the components results in the collapse of the expanded PTFE structure before impregnation can occur.

Solvent based coatings readily wet hydrophobic PTFE; however, the added cost of processing and environmental impact with solvents makes this approach undesirable. Tu teaches the impregnation of expanded PTFE with a fluoroelastomer solvated in methylene chloride. The article is submerged into the solution whereby the polymer wets the ePTFE structure. The article is then dried to leave a porous product. A difficulty in processing FFKM polymers in this way is that the solubility is so low that only about 5 wt % polymer can be readily dissolved in a perfluorinated solvent. Even at this low solids content, the solution has a viscosity above 10,000 cp. As a result, when solutions of FFKM are applied to ePTFE structures, only a small amount of elastomer is incorporated into the structure, and a barrier film forms on the outside of the article, thus limiting further addition of elastomer.

Emulsion polymerization is desirable for the ability to manufacture large quantities of polymers for many applications (Encyclopedia of Polymer Science), and is useful for producing high molecular weight polymers without the need for organic solvents. The resulting emulsions are discreet polymer particles dispersed in an aqueous medium. Emulsions of elastomeric polymers may readily wet hydrophilic surfaces; however, upon exposing the emulsions to the surface of the hydrophobic expanded PTFE, the emulsions typically bead up and roll off of the membrane surface without wetting into the structure. Emulsions of elastomers such as natural rubber, styrene butadiene rubber, and fluoroelastomers (FKM) are all readily available with solids levels of between 10% and 60 wt %; however, nearly all of them are incapable of readily wetting expanded PTFE structures. Surprisingly, emulsions of FFKM have been identified which spontaneously wet ePTFE and can be used to deliver very high molecular weight polymer.

### SUMMARY OF THE INVENTION

An objective of this invention is to provide a composite in which FFKM elastomers are reinforced with ePTFE having enhanced mechanical properties when compared to composites of elastomers reinforced with particulate filler. One preferred composite comprises an expanded PTFE and an FFKM elastomer comprising TFE and PAVE, where both the ePTFE reinforcement and the FFKM elastomer are co-continuous within the composite. A porous ePTFE structure is provided having a node and fibril microstructure whereby the pores are filled with elastomer so as to render at least a portion of the structure substantially non-permeable. The inventive composite utilizes ePTFE to provide mechanical reinforcement to the elastomer without employing particulate fillers as reinforcement where such fillers can lead to contamination. The resulting composite has increased flex endurance, greater inertness, and reduced particulate emission superior to other particulate reinforced elastomers.

Another objective of this invention is a method for preparing ePTFE reinforced FFKM elastomers for use as intermediate composites and directly into final articles. In one method of the present invention an aqueous emulsion of FFKM elastomer is imbibed into the ePTFE structure. Elastomeric emulsions of the present invention wet the ePTFE structure upon contact and spontaneously imbibe into the porous structure, and have sufficient solids content to render at least a portion of the ePTFE structure substantially non-permeable upon removal of water and volatiles.

A further objective is a method of producing a thin film of ePTFE reinforced FFKM elastomer without subjecting the compound to high shear mixing that can lead to “scorching”, and/or a reduction of molecular weight. This method also yields a thinner film than can be obtained by conventional calendering techniques.

Another object of this invention is to incorporate the reinforcing agent, ePTFE into the FFKM without the need to coagulate and isolate the polymer from the emulsion. Thus, FFKM emulsions can be used which are known to have the lowest cost structure, and without environmentally harmful solvents.

Another objective is to provide a method of making reinforced FFKM elastomeric components, utilizing high molecular weight TFE/PAVE polymers which cannot be feasibly dissolved or processed. Preferred methods of the present invention enable the incorporation of high molecular weight FFKM elastomers into composites of the present invention that typically cannot be dissolved or readily processed. Therefore, the composite structures can be fabricated from high molecular weight FFKM having enhanced mechanical properties than are usually deemed achievable for this class of elastomer.

It is a further objective of this invention to provide durable articles such as pump tubes, release liners, hose liners, diaphragms, o-rings, flexible hinges, gaskets, such as fuel cell gaskets, etc., that would benefit from the use of expanded PTFE microstructure to improve the mechanical properties of the FFKM elastomer.

### DETAILED DESCRIPTION OF THE INVENTION

The present invention provides an elastomeric composite of FFKM polymer reinforced with an expanded polytetrafluoroethylene (ePTFE), the FFKM polymer preferably comprising a polymer of tetrafluoroethylene (TFE) and perfluoroalkyl vinyl ether (PAVE). The resulting composite has elastomeric properties of the FFKM polymer and the strength of ePTFE without any particulate impurities which commonly result from other methods of reinforcing FFKM polymers, and further, without any reduction in molecular weight which commonly results from known methods of processing FFKM polymers with filler. Preferred embodiments include composites wherein the ePTFE reinforcement and the FFKM are continuous throughout the composite.

It has been surprisingly discovered that aqueous microemulsions of high molecular weight FFKM polymers are capable of readily wetting and substantially filling at least a portion of hydrophobic ePTFE structures. FFKM emulsions capable of wetting and imbibing into the ePTFE structure can be prepared which have a polymer solids content sufficiently high enough for the polymer to substantially fill and render at least a portion of the ePTFE structure non-permeable.

Moreover, it has been discovered that high molecular weight FFKM polymers that have limited solubility in solvents and limited processibility in solid form can be readily incorporated into the ePTFE structure in amounts not possible by current techniques providing composites having enhanced mechanical properties. Thus, a preferred method of preparing composites having a high resin content of FFKM polymer in the ePTFE microstructure comprises the steps of providing the ePTFE structure with an emulsion having an FFKM polymer, and allowing the emulsion to wet the structure and the FFKM particles to substantially fill or imbibe into the porous structure rendering at least a portion of the structure substantially non-permeable.

Expanded PTFE is provided which is produced such as through the methods described in U.S. Pat. No. 3,953,566, to Gore. The resulting product has a porous microstructure characterized by nodes and fibrils defining a plurality of interconnected passages and pathways. In the case of uniaxial expansion the nodes are elongated, the longer axis of the node being oriented perpendicular to the direction of expansion. The fibrils which interconnect the nodes are oriented parallel to the direction of expansion. The ePTFE structure can also be modified in many ways to change the properties of the composite in orthogonal planes. Preferably the nodes and fibrils within the ePTFE define interconnected passages and pathways to form a continuous matrix. The interconnection of nodes and fibrils provide mechanical reinforcement for the elastomer. In a preferred embodiment a structure of ePTFE to be imbibed with the FFKM polymer comprises a continuous interconnection of nodes and fibrils which form passages and pathways extending throughout the structure.

Typical properties of an ePTFE structure suitable for use in the present invention may comprise an average fibril length between nodes of 0.05 to 30 microns, preferably between 0.2 and 30 microns, and a void volume of from about 20% to about 99%. As should be evident from the following description, the precise properties and dimensions of ePTFE structures employed with the present invention are a function of the application. Substrate material made through one of the above described methods and suitable for use in the present invention is commercially available in a wide variety of forms from a number of sources, including from W. L. Gore & Associates, Inc. (Newark, Del.) under the trademark GORE-TEX (a registered trademark of W. L. Gore & Associates, Inc.)

A preformed structure of ePTFE is preferably provided as a scaffold to the composite. The ePTFE “scaffold” structure comprises a node and fibril microstructure having passages and pathways that form a continuous matrix to provide structural and mechanical reinforcement to the elastomeric component. The preformed ePTFE structure or scaffold may comprise any shape or form suitable for use in the present invention.

The term FFKM elastomer or polymer, as used in the present invention, is intended to include perfluorinated elastomers that may be crosslinked or uncrosslinked. Preferred FFKM polymers comprise tetrafluoroethylene (TFE) and perfluoroalkyl vinyl ether (PAVE) monomers having the following structure:

CF₂=CFOR_{f}

wherein R_{f} is a C₁-C₈ perfluoroalkyl group. Polymers comprising TFE and perfluoromethyl vinyl ether (PMVE) monomers are preferred. A copolymer comprising TFE and PMVE monomers is particularly preferred. FFKM polymers suitable for use in the present invention may also comprise cross-linking monomers and/or curing agents.

Polymers comprising TFE and PMVE are obtainable from a number of sources, and may be prepared by any method known in the art, such as those methods described in the patents cited supra in the Background section, and in Canadian Patent No. 894898 to Gallagher. Preferably, TFE and PMVE monomer units are present in amounts in the polymerization reaction to produce a polymer which contains about 20% to 80% by weight of TFE and complementally about 80% to 20% by weight of PMVE, determined by NMR (nuclear magnetic resonance) or IR (infrared). Most preferably these weight percents will be 30% to 70% TFE and 70% to 30% PMVE. The concentration of PMVE within these ranges, among other things, contributes to the elastomeric and low temperature characteristics of the polymer. Most preferred is a TFE/PMVE polymer that is amorphous. Polymers produced for purposes of the instant invention are preferably solid at room temperature. Where the polymer comprises crosslinking monomers, crosslinking can be accomplished by any suitable method known to one skilled in the art.

The preferred polymerization reaction is an emulsion polymerization in which the catalyst and the monomers are maintained in an aqueous emulsion by soaps or emulsifying agents. The resulting emulsions preferably have a solids content of about 10% to 80% by weight TFE/PMVE polymer, and readily wet and imbibe into the ePTFE membrane. Emulsions having a solids content of greater than about 50% are preferred, with emulsions having a solids content of about 50% to 70% by weight of the TFE/PMVE polymer being particularly preferred. Also preferred are emulsions having about 60% by weight or greater of the TFE/PMVE polymer. The term “emulsion” or “microemulsion” is used herein to describe the dispersion of discreet polymer particles in an aqueous environment.

One preferred embodiment of the present invention comprises a membrane of ePTFE having a porosity of about 95% and a thickness of about 2.5 mm. The membrane is imbibed with an emulsion comprising a high molecular weight copolymer of TFE and PMVE to form a composite wherein at least a portion of the composite is non-permeable. It was surprisingly found that thick structures of ePTFE, such as this, could be readily wetted by emulsions of the present invention, and the emulsions imbibe into the porous structure to render at least a portion of the composite non-permeable.

Additional components, such as emulsifying agents, may be added to the emulsion or applied directly to the ePTFE structure prior to the application of emulsion. Ammonium perfluoro octanoate is a preferred emulsifying agent that may be used to aid in the wetting of the ePTFE. The amount of emulsifying agent to be added depends in part on the solids content of the polymer emulsion, and the surface area and hydrophobic nature of ePTFE. Preferably, the emulsifying agent is added in an amount of between 1 and 20% by weight to either the emulsion or a solution used to pre-treat the ePTFE.

Preferred articles of the present invention are made from ePTFE-reinforced FFKM elastomer composites having an elastomer content of about 50% to about 99% by weight of the composite. Articles of the present invention may be fabricated from composites of the present invention alone or with at least one additional material, including but not limited to other FFKM elastomers, ePTFE, and ePTFE-reinforced FFKM elastomers.

A method is provided which is directed to forming a composite by providing a scaffold of porous ePTFE and an emulsion of a polymer comprising TFE and PAVE, and substantially filling the porous scaffold with the polymer to render at least a portion of it substantially non-permeable.

By ‘substantially filling’ or ‘substantially filled’ it is meant that at least a portion of the article or composite is rendered substantially non-permeable by the application of the emulsion to ePTFE. In one preferred embodiment, the ePTFE structure, prior to being imbibed with elastomer, is white in appearance indicating porosity, and the visual appearance of the TFE/PMVE polymer emulsion is clear. Surprisingly, the visual appearance of the resulting ePTFE-reinforced elastomeric composite is also clear indicating that the passages and pathways of the ePTFE structure have been substantially filled, and at least a portion of the composite is rendered substantially non-permeable. By “substantially non-permeable” as used herein is meant resistant to the transport of air or liquids through a material. Permeability may be measured using any known technique such as described in TAPPI specification T460-96 for Gurley, where samples having a Gurley number of greater than about 5000 seconds are deemed substantially non-permeable. In one embodiment, where at least a portion of the ePTFE structure is rendered non-permeable by the FFKM elastomer, the composite may be particularly useful, for example for forming articles such as pump tubing. In an alternate embodiment, a portion of an article of the present invention may be rendered non-permeable and a portion of the article may remain porous. This may be particularly useful where the article comprises a gasket used in plastic flanges to provide a fluid tight seal for process piping.

A preferred method of making a substantially non-permeable article comprises the steps of:

(a) providing a scaffold of expanded polytetrafluoroethylene (ePTFE) having a microstructure defining a plurality of interconnected passages and pathways;

(b) providing an emulsion of a polymer comprising TFE and PAVE;

(c) dispensing the emulsion onto the scaffold and allowing the emulsion to imbibe into, and substantially fill the passages and pathways of the scaffold to render at least a portion of the article substantially non-permeable.

According to this method the emulsion may be provided to the scaffold of ePTFE by any one of a variety of methods familiar to one skilled in the art, including brushing, dipping, spraying, or gravure coating. Preferably, the ePTFE is wetted by an emulsion of a TFE/PMVE polymer that rapidly imbibes into the porous ePTFE. Alternately, the ePTFE structure may be wetted prior to dispensing the emulsion to the structure, such as by wetting the structure with a solvent. The emulsion is preferably dispensed onto the ePTFE to substantially fill the passages and pathways in one application, however, two or more than two applications may be provided where, for example, the solids content of the polymer are not high enough to render the structure non-permeable in a single application.

The emulsion may be applied to one or more surfaces of ePTFE substantially filling the pores and rendering at least a portion of the composite non-permeable. Moreover, the emulsion may be applied to the ePTFE structure forming an elastomer-rich section on a portion of the composite. For example, in one embodiment, an ePTFE-reinforced FFKM elastomer composite is formed which further comprises a layer of elastomer on at least a portion of at least one surface of the composite.

A multilayered or laminate composite may be formed by providing an ePTFE-reinforced FFKM elastomer composite, and further providing at least one additional layer. Preferably, the at least one additional layer is selected from an ePTFE-reinforced FFKM elastomer composite, an elastomer layer, or an ePTFE layer. Where the at least one additional layer is an elastomer, the elastomer is preferably a TFE/PMVE polymer or copolymer. However, other elastomers may be selected which reduce costs and introduce other properties, such as neoprene, natural rubber, styrene butadiene rubber, ethylene propylene diene monomer, urethane rubber, nitrile rubber, silicone, and the like. One or more additional layers may be applied to one or more surfaces of the at least one layer of ePTFE-reinforced FFKM elastomer, and may be applied by any known method of adhesion or lamination.

After the step of dispensing the emulsion onto the scaffold and allowing the emulsion to imbibe into the passages, the method may further comprise the step of drying the article. The article may be dried, for example, to remove water and surfactant from the emulsion. Drying is accomplished by any of a variety of methods that would be known to one skilled in the art, for example by heating, air-drying, extraction, and the like.

Further, where the polymer comprises cross-linking monomers, heat or other energy sources may be applied in an additional step to cross-link the polymer.

Articles formed from composites of the present invention have increased flex endurance when compared to articles comprising perfluoroelastomers without reinforcement. In comparison to articles fabricated from perfluoroelastomers reinforced with particulate reinforcements, articles of the present invention have higher purity through reduced particulate emissions. Articles of the present invention are suitable for numerous applications and are particularly preferred where high purity and elastomeric characteristics are crucial such as for hose and tube liners, tubing such as peristaltic pump tubing, flexible hinges, O-rings, gaskets, flexible connectors, release films, diaphragms, and the like. In one particularly preferred embodiment, fuel cell gaskets are prepared from ePTFE reinforced TFE/PMVE polymers of the present invention.

### EXAMPLES

### Example 1

A TFE/PMVE polymer emulsion was imbibed into an ePTFE membrane.

Approximately 800 g of an aqueous emulsion was prepared having about 12.7 wt % solids content of an amorphous high molecular weight TFE/PMVE copolymer, the copolymer having about 50%-60% by weight of PMVE, a modulus of about <7 MPa, and greater than 100% elongation. The emulsion was charged into a one-liter Nalgene PP container with approximately 30 g of APFO powder, stirred into solution with a magnetic stirrer.

One application of the emulsion was brushed onto an e PFTE membrane having a porosity of about 85% and a thickness of about 0.09 mm (W. L. Gore and Associates, Newark, Del.); the emulsion took about 15 seconds to penetrate the membrane. The membrane was then dried at about 200° C. for about 3 minutes forming a composite. After drying, the composite was stiffer and less sticky than the unimbibed membrane. A section of the membrane that changed from white to clear upon application of the emulsion remained clear after drying.

### Example 2

An ePTFE-reinforced TFE/PMVE polymer film was produced.

Approximately 2,751 grams of an aqueous emulsion of the TFE/PMVE polymer of Example 1 was heated in a 4-liter beaker on a magnetic stirrer/hot plate (VWR model 320) to evaporate water. An emulsion of approximately 22.8 wt % solids was obtained. A final emulsion was prepared as follows. Approximately 800 g of the 22.8 wt % solids of a TFE/PMVE copolymer was charged into a one-liter Nalgene PP container with approximately 50 g of APFO powder, and stirred into solution with a magnetic stirrer.

The final emulsion was applied to an e PFTE membrane having about 85% porosity and a thickness of about 0.09 mm (W. L. Gore & Associates, Newark, Del.) by brushing on to one side of the membrane until the appearance of the membrane changed from white to transparent. The membrane was then dried at about 200° C. for about 3 minutes to form a composite.

Approximately 75% of the composite was transparent after drying; the TFE/PMVE polymer content of the composite was approximately 47.0 wt %.

The clarified region of the membrane was tested for air permeability using the Gurley test. The sample had a Gurley number of greater than 20,000 seconds indicating that it was air impermeable.

### Example 3

An ePTFE-reinforced TFE/PMVE polymer film was produced.

An emulsion having approximately 22.8 wt % solids content and prepared substantially according to Example 2, was applied to an ePFTE membrane having a porosity of about 85% and a thickness of about 0.09 mm (W. L. Gore and Associates, Newark, Del.). The emulsion was brushed onto both top and bottom sides of the membrane until the appearance of the membrane changed from white to clear. The membrane was then dried at about 200° C. for about 3 minutes to form a composite, and remained transparent after drying. The TFE/PMVE polymer content of the composite was approximately 43.0 wt %.

### Example 4

An ePTFE-reinforced TFE/PMVE polymer film was produced.

A stainless steel tray was wrapped with an ePTFE membrane having about 75% porosity and a thickness of about 0.035 mm (W. L. Gore & Associates, Newark, Del.). About 50 ml of an emulsion of an amorphous TFE/PMVE copolymer, having about 40.8 wt % PMVE, and having a solid content of about 14.6 wt %, including about 2.1 wt % APFO, was prepared and then poured on top of the ePTFE membrane. The stainless steel tray was placed in a forced air convection oven at about 100° C. for about 3 hours. The emulsion wet through the membrane onto the tray. The resulting material was translucent indicating that the membrane pores were filled with TFE/PMVE polymer.

The imbibed membrane had a Gurley number of greater than 20,000 seconds indicating that it was air impermeable.

### Example 5

An ePTFE-reinforced TFE/PMVE polymer film was produced.

An ePTFE membrane having about 75% porosity and a thickness of about 0.035 mm (W. L. Gore & Associates, Newark, Del.) was clamped in an 8″ sanitary flange and wetted with IPA. The wetted membrane was then rinsed and soaked in water for about 2 hours. The membrane was removed from water. About 50 ml of the emulsion of Example 4 was poured into the flange and onto the membrane. The flange was placed in the oven for about 2 hours. For support, a piece of low density ePTFE material was placed under the membrane on a 6″ disk of aluminum. The sample was removed from the oven and peeled from the low density ePTFE material. The material was transparent indicating that the membrane was completely imbibed with the TFE/PMVE polymer.

### Example 6

An ePTFE-reinforced TFE/PMVE polymer film was produced.

An ePTFE membrane having a thickness of 0.25 mm and a porosity of about 80% (W. L. Gore and Associates, Newark, Del.) was placed in a beaker full of IPA. The membrane was placed in water overnight. The water-wetted membrane was placed on a tray and 50 ml of the TFE/PMVE copolymer emulsion of Example 4 was poured on top of the membrane. After about 3 hours, the sample was removed. The material was transparent indicating that the polymer had wet the structure and substantially filled the pores, and was placed in an oven at about 100° C. and dried.

### Example 7

In this example a tubular ePTFE-reinforced TFE/PMVE polymer is prepared and flex tested using the Newark flex test method substantially according to the method described in U.S. Pat. No. 6,016,848. The flex samples had an internal diameter of about 38 mm, a wall thickness of about 1.0 mm, and a length of about 75 mm.

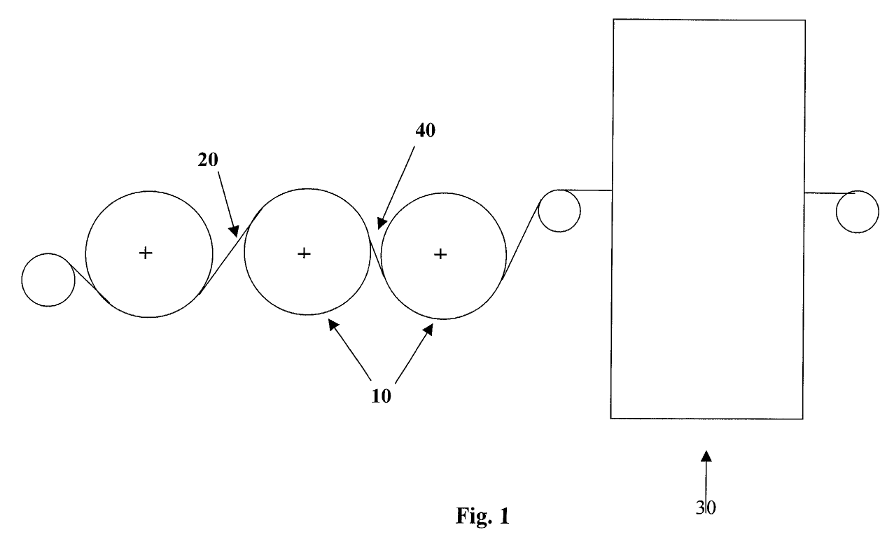

The ePTFE—reinforced TFE/PMVE polymer is prepared by coating an ePTFE structure having a porosity of about 87% and a thickness of about 0.023 mm (W. L. Gore & Associates, Newark, Del.), with a 63% by weight solids emulsion of a high molecular weight TFE/PMVE copolymer having about 5 wt % APFO. The emulsion 40 was applied to the ePTFE structure using the apparatus illustrated in FIG. 1. The film was passed through a 0.075 mm-0.1 mm gap between two chrome rolls 10, which resulted in spontaneous clarification of the membrane 20. The film was conveyed into a forced air convection oven 30 at about 0.6 meter per minute to dry the film at approximately 200° C. The resulting film (having a thickness of 0.038 mm) was wrapped around a 38 mm diameter mandrel and heated at about 177° C. under vacuum and pressure in an autoclave to remove volatiles and trapped air.

Two samples of an ePTFE reinforced TFE/PMVE polymer tubular structure were tested and neither sample failed after greater than 10 million cycles.

### Comparative Example 1

A tubular structure was formed from a sheet of calendered peroxide curable TFE/PMVE polymer. The calendered sheet was wrapped on a 38 mm mandrel and heated to about 177° C. to affect crosslinking in an autoclave where the sample was subjected to vacuum and external pressure.

The unreinforced tubular structure was flex tested using the Newark flex test method according to Example 7. Two samples of the unreinforced tubular structure of this example were tested and failed at about 800,000 cycles and 2 million cycles.

### Example 8

An ePTFE structure having a porosity of about 94% and a thickness of about 2.5 mm and prepared substantially according to U.S. Pat. No. 4,385,093 (W. L. Gore and Associates, Newark, Del.) was imbibed with an emulsion of a TFE/PMVE copolymer having a solids content of about 63 wt %. The emulsion was applied to the ePTFE structure, and the composite was dried at room temperature and then heated to about 150° C. for about 1 hour. The resulting composite was clear, and had a Shore A hardness value of 72, and an end thickness of about 1.2 mm.

### Example 9

An e PFTE-reinforced TFE/PMVE pump tube is prepared and tested in a peristaltic pump. An ePTFE structure having about 80% porosity (W. L. Gore and Associates, Newark, Del.) was formed as a tube having an internal diameter of 3.2 mm and a wall thickness of 1.6 mm. The tubing was formed from the film of Example 7. The film was wrapped onto a 3.2 mm mandrel and placed in a compression mold at about 100° C. for about 2 hours. The tubing was imbibed with an emulsion of a 63 wt % solids content TFE/PMVE copolymer and dried.

The tubing was mounted in a Masterflex® L/S pump head (model # 701-20) and operated for about 100 hours at 600 rpm before the flow rate dropped more than 50% from the initial flow rate of 520 ml/min.

### Comparative Example 2

A pump tube was formed from a film of a calendered TFE/PMVE polymer as described in Comparative Example 1. The film was wrapped around a 3.2 mm mandrel and compression molded at about 100° C. for about 4 minutes and then ramped to about 177° C. for 3 hours and cooled to room temperature overnight. The resulting tube had dimensions of about 3.2 mm internal diameter and about 1.6 mm wall thickness. The pump tube was mounted in a Masterflex® L/S pump head (model # 701-20) and operated at about 600 rpm for about 1 minute before cracking along the axis of the tube.

### Example 10

A slab of multilayered TFE/PMVE-imbibed ePTFE was prepared.

Using the gravure coating process described in Example 7, expanded PTFE films were imbibed with an emulsion of a 63 wt % solids content TFE/PMVE copolymer. An expanded PTFE membrane was used in the coating process having a thickness of 0.023 mm, a weight per area of 0.648 mg/cm², and a porosity of about 87% (W. L. Gore and Associates, Elkton, Md.). The gap thickness between the chrome coating rolls was set to between 0.10 and 0.12 mm. The coating process was operated at speed of about 1.5 meters per minute. The temperature of the film heating zones were set to achieve a final film surface temperature of about 200° C., measured using thermal tape on the surface of the film during the heating cycle. The TFE/PMVE emulsion-coated ePTFE film had a thickness of about 0.036 mm, a weight per area of 6.45 mg/cm².

To fabricate a multilayered slab, 72 layers of the TFE/PMVE-imbibed ePTFE film were stacked and then cut into a 140×140 mm square. This was then placed in a platen mold having internal dimensions of about 152 mm×152 mm×2.0 mm. The mold was pressed at about 200 MPa, and at a temperature of about 177° C. for 45 minutes. The mold was allowed to cool to room temperature under compression to eliminate sample blistering due to outgassing. The resulting sample demonstrated no blistering and had the following dimensions after removal from the mold, a thickness of 2.0 mm, width of 152 mm, length of 152 mm, and a Shore A durometer of 88.

### Example 11

A crosslinked slab of multi-layered TFE/PMVE-imbibed ePTFE film was prepared.

Using the TFE/PMVE-imbibed ePTFE film described in Example 10, a crosslinked slab was produced. Urea was used as a crosslinking catalyst to initiate crosslinking in the TFE/PMVE copolymer material. Urea powder was produced by grinding urea crystals (Aldrich Chemical Co.) with a mortar and pestle and screening through a No.140 sieve (106 micron). This powder was then dusted onto 140×140 mm squares of the TFE/PMVE-imbibed ePTFE film. Seventy-two (72) urea-powder coated film samples were made this way, each having approximately 4 wt % urea powder coating. These squares were then stacked (urea powder coated side up) and placed in the platen mold described in Example 10. This mold was placed in the press at temperature of about 177° C. and a pressure of about 300 MPa for 45 minutes. The sample was then cooled to room temperature before the pressure was released. The sample had a thickness of about 2.0 mm and a Shore A durometer of 87.

A 10 mm×10 mm×2.0 mm sample of this material was placed in 100 ml of fluorosolvent (PF5080, 3M Corporation). For comparison, a 10 mm×10 mm×2 mm sample of the slab produced in Example 10 was placed in a separate bottle containing 100 ml of the same fluorosolvent. After 2 days of immersion, significant swelling occurred in both samples. Observations made after 5 days showed that layer delamination had occurred in the sample fabricated without urea (Example 10) indicating the TFE/PMVE polymer dissolved. In the sample of Example 11, prepared with urea, the layers remained well bonded even after rigorous agitation, demonstrating that crosslinking had occurred in the TFE/PMVE copolymer containing a cure site co-monomer.

### Example 12

A ring gasket having a 47.6 mm outer diameter and a 31.2 mm internal diameter was cut from the slab of crosslinked TFE/PMVE-imbibed ePTFE composite film fabricated in Example 11. The ring gasket was tested for stress to seal at a stress of 1.7 MPa (approximately 250 psi) and 3.4 MPA (approximately 500 psi). The results are reported in Table 1.

TABLE 1
Stress to Seal Data

| | ID | OD | Thickness | Stress | Leak rate |
|---|---|---|---|---|---|
| Example | (mm) | (mm) | (mm) | (MPa) | (ml/hr) |
| Example 12 | 31.2 | 47.6 | 2.09 | 1.7 | 24.0 |
| Example 12 | 31.2 | 47.6 | 2.09 | 3.4 | 0.0 |
| Example 13 | 31.0 | 48.1 | 2.79 | 1.7 | 0.48 |
| Example 13 | 31.0 | 48.1 | 2.79 | 3.4 | 0.03 |
| Example 14 Imbibed | 32.1 | 50.2 | 3.23 | 1.7 | 0.24 |
| Example 14 Unimbibed | 33.0 | 51.2 | 3.16 | 1.7 | 16.9 |
| Example 14 Unimbibed | 33.0 | 51.2 | 3.16 | 20 | 0.72 |
| Example 15 | 32.1 | 50.2 | 0.25 | 3.4 | 145.0 |
| Example 15 | 32.1 | 50.2 | 0.25 | 5.1 | 0.05 |

### Example 13

An imbibed ePTFE ring gasket (provided by W. L. Gore and Associates, Inc. under the trade name Gore-Tex® GR sheet gasket) having an internal diameter of 31.0 mm and an outer diameter of 48.1 mm, and having an initial weight of 2.51 g, was coated with a TFE/PMVE copolymer emulsion having 63 wt % solids content. The ring gasket was immersed in the emulsion for about 24 hours, allowing the emulsion to imbibe into the surface porosity. The gasket was removed from the emulsion and dried at room temperature for about two days and determined to have a weight increase of about 110%. The imbibed gasket sample was then tested for stress to seal. The results are shown in Table 1.

### Example 14

An imbibed ePTFE ring gasket (provided by W. L. Gore and Associates, Inc. under the trade name GORE-TEX® GR sheet gasket) having an internal diameter of 32.1 mm and an outer diameter of 50.2 mm, and having an initial weight of 2.50 g, was coated with a 63 wt % solids content of a TFE/PMVE copolymer emulsion. The ring gasket was immersed in the emulsion for about 90 minutes, allowing the emulsion to imbibe into the surface porosity. The gasket was removed from the emulsion and dried at room temperature for about two days and determined to have a weight increase of about 51%. The imbibed gasket sample was then tested for stress to seal and compared to that of an unimbibed ePTFE ring gasket having an internal diameter of 33.0 mm and an outer diameter of 51.2 mm.

Stress to Seal Testing

Sealability of the gaskets was determined by leak rate tests performed in accordance with procedures and equipment outlined in ASTM F37-95 Test Method B. The test fluid was air at 0.207 MPa (30 psi). The gaskets were loaded to the selected compressive stress between two smooth steel press platens with a surface finish of RMS 32 held at room temperature. The gaskets were then subjected to the 0.207 MPa internal air pressure introduced into the center of the annular gasket that is compressed between the press platens. The air pressure within the test assembly was then isolated from the environment by closing a valve. The leakage rate was determined by a change in the level of manometer fluid located in the line upstream from the gasket test fixture over a period of time. The change in the manometer was due to air leakage past the gasket to the environment resulting in loss of internal air pressure. The manometer readings were converted to leakage rates using the equation below:

$$LR = \frac{MR * 2.54 * A * 60}{T * SG}$$

where:

LR is Leakage Rate (ml/hr)

MR is manometer reading (inches)

2.54 constant is to convert manometer reading from (in) to (cm)

A is the cross sectional area of inside the manometer tube (cm 2)

T is time (min)

60 constant is to convert time from (min) to (hr)

SG is specific gravity of manometer fluid

The manometer linear scale must match the specific gravity of the fluid used. In this test, the manometer scale was calibrated for 1.0 specific gravity fluid. The fluid used was Meriam 100 Unity Oil (specific gravity 1.0) commercially available from Meriam Instrument Company of Cleveland, Ohio. The manometer used had an internal tube diameter of 0.25 inches (0.635 cm). Manometer readings were taken at ten and thirty minutes. The results are shown in Table 1.

### EXAMPLE 15

An ePTFE-reinforced TFE/PMVE polymer film was produced for use as a gasket in manufacturing a fuel cell assembly.

An ePTFE membrane having a thickness of 0.25 mm and a porosity of about 78% (W. L. Gore and Associates, Newark, Del.) was supported in a 4-inch diameter embroidery hoop. About 50 ml of the TFE/PMVE copolymer emulsion of Example 7 was poured on top of the membrane. The solution completely wetted through the membrane in about 15 minutes, and the sample was dried in an oven at 100° C. for 30 minutes. The material was partially transparent, and a layer of polymer film covered the entire surface of the membrane making it non-permeable to air. The imbibed material had a thickness of 0.25 mm. A ring gasket having an outer diameter of 50.2 mm and an inner diameter of 32.1 mm was cut from the sheet of imbibed membrane. The coated gasket was tested for stress to seal, and the results are reported in Table 1.

1. A reinforced elastomer composite comprising expanded polytetrafluoroethylene (ePTFE) having a node and fibril microstructure defining a plurality of interconnected passages and pathways to form a continuous matrix, and a polymer comprising monomer units of TFE and PAVE substantially filling a portion of said passages and pathways, at least a portion of the composite being substantially non-permeable.

2. A reinforced elastomer composite of claim 1, wherein the ePTFE comprises a preformed structure.

3. A reinforced elastomer composite of claim 1, wherein the ePTFE comprises a scaffold.

4. A reinforced elastomer composite of claim 1, wherein the PAVE monomer units are PMVE.

5. A reinforced elastomer composite of claim 4, wherein the polymer comprises between about 20 and 80% by weight TFE and between about 80 and 20% by weight PMVE.

6. A reinforced elastomer composite of claim 4, wherein the polymer comprises between about 30 and 70% by weight TFE and between about 70 and 30% by weight of PMVE.

7. A reinforced elastomer composite of claim 1, wherein the polymer is amorphous.

8. A reinforced elastomer composite as defined in claim 1, wherein the polymer further comprises a crosslinking monomer.

9. A reinforced elastomer composite as defined in claim 1, further comprising a curing agent.

10. A reinforced elastomer composite as defined in claim 1, wherein the polymer is crosslinked.

11. A reinforced elastomer composite as defined in claim 1, further comprising at least one additional layer.

12. An article comprising
a reinforced elastomer composite comprising
a polymer comprising TFE and PAVE, and
a scaffold of porous ePTFE,
the polymer substantially filling a portion of the pores, and
wherein at least a portion of the reinforced elastomer composite is substantially non-permeable.

13. An article of claim 12, said reinforced elastomer composite further comprising an elastomer-rich section on a portion of the composite.

14. An article of claim 12, further comprising at least one additional material.

15. An article of claim 14, wherein the at least one additional material is selected from ePTFE-reinforced FFKM composite, an elastomer, and an ePTFE layer.

16. An article of claim 15 wherein the elastomer is a TFE/PMVE elastomer.

17. An article of claim 12 wherein PAVE is PMVE.

18. An article of claim 12 wherein the article comprises a gasket.

19. An article of claim 12 wherein the article comprises a fuel cell gasket.

20. An article of claim 12 wherein the article comprises an o-ring.

21. An article of claim 12 wherein the article comprises a flexible hinge.

22. An article of claim 12 wherein the article comprises a tube.

23. An article of claim 22 wherein the tube is peristaltic pump tube.

24. An article of claim 12 wherein the article comprises a tube liner.

25. An article of claim 12 wherein the article comprises a release film.

26. An article of claim 12 wherein the article comprises a diaphragm.

27. A method of making a substantially non-permeable article comprising the steps of:
(a) providing a scaffold of expanded polytetrafluoroethylene (ePTFE) having a microstructure defining a plurality of interconnected passages and pathways to form a continuous matrix;
(b) providing an emulsion of a polymer comprising TFE and PAVE;
(c) dispensing said emulsion onto said scaffold, said emulsion imbibing into at least a portion of said passages and pathways of said scaffold to render the article substantially non-permeable.

28. The method of claim 27 wherein said emulsion has a solids content of about 10 to 70%.

29. The method of claim 27 wherein PAVE is PMVE.

30. The method of claim 29, wherein said emulsion has a solids content of about 50% to 70% by weight of the polymer comprising TFE and PMVE.

31. The method of claim 29, wherein said emulsion has a solids content of about 60% by weight or greater of the polymer comprising TFE and PMVE.

32. The method of claim 29, wherein the polymer comprises between about 20 and 80% by weight TFE and between about 80 and 20% by weight PMVE.

33. The method of claim 29, wherein the polymer comprises between about 30 and 70% by weight TFE and between about 70 and 30% by weight PMVE.

34. The method of claim 27 further comprising the step of drying said substantially non-permeable article.

35. The method of claim 27 wherein the polymer further comprises a crosslinking monomer.

36. The method of claim 27 wherein the polymer further comprises a curing agent.

37. The method of claim 27 further comprising crosslinking the polymer comprising TFE and PAVE.

38. The method of claim 27 wherein the emulsion further comprises an emulsifying agent.

39. The method of claim 27 further comprising allowing the emulsion to imbibe into substantially all of the passages and pathways of the scaffold.

40. A method of forming an ePTFE-reinforced FFKM polymer composite comprising providing a scaffold of porous ePTFE and an aqueous emulsion of a TFE/PAVE copolymer, substantially filling the pores with the polymer, and rendering at least a portion of the composite substantially non-permeable.
